(19) United States
(12) Patent Application Publication
(10) Pub. No.: US 2013/0180442 A1
(43) Pub. Date: Jul. 18, 2013

(54) SYSTEM FOR HANDLING CARGO

(71) Applicant: Einar Pedersen, Bergen (NO)

(72) Inventor: Einar Pedersen, Bergen (NO)

(21) Appl. No.: 13/704,883

(22) PCT Filed: Jul. 7, 2011
(86) PCT No.: PCT/NO11/00195

§ 371 Date: Apr. 4, 2013

(30) Foreign Application Priority Data
Jul. 12, 2010 (NO) 20100998

(51) Int. Cl. B63B 25/22; B65D 19/00; B60P 1/02

(52) U.S. Cl. CPC B63B 25/22; B60P 1/02; B65D 19/0053
USPC 114/72; 211/49.1; 414/800; 414/495; 108/56.1

(57) ABSTRACT

The present invention relates to a system for handling cargo on board and to/from a vessel, wherein said system includes a cargo vessel with a plurality of cargo decks, a number of side doors, a cargo elevator located inside each side door communicating with said cargo decks, and a crane located inside each side door, the system further includes a number of standardized cargo load platforms with legs, the cargo load platforms being adapted to store cargo, the cargo load platforms being stored on the cargo decks in slots along the sides of the vessel and transverse to the longitudinal axis of the vessel and with a passageway between the slots along the longitudinal axis of the vessel, the system further includes a number of trolleys adapted to transport the load platforms between the slots and the cargo elevators.

### FIELD OF THE INVENTION

The present invention relates to the field of shipping of cargo and, in particular, to a system for handling cargo on board and to/from a vessel.

### BACKGROUND

The invention of containers by Malcolm McLean in 1956 led to the ISO 40 Ft and 20 Ft containers to make loading of ships more efficient and to reduce pilferage. Containers have since become the backbone of international non bulk ocean borne cargo flows and have made the ocean portion of the global logistics chain very cost efficient. Special purpose container vessels have been developed carrying up to 18,000 TEU (Twenty ft Equivalent Units). In the container vessels, the containers are stacked on top of each other making multiport operation difficult due to limited access to the containers.

On the land side, container terminals have had to be built with significant investments where large cranes are used to unload the container vessels, whereafter the containers are stored for retrieval and transfer to inland means of transportation or to transfer them to feeder vessels for transport to secondary regional ports. The concentration of traffic to populated areas with a hinterland of industrial/economical activity has resulted in concentration of container traffic to very large container ports and to congestion in unloading large container vessels and congestion when transporting containers inland.

Due to the design of the containers they cannot be transported by mechanized conveyors, thereby limiting the options in respect of mechanization onboard the vessel and in the terminals.

The use of containers as a cargo carrier creates a ripple down effect of activities and cost, investments in the containers, the transport of full and empty containers, the cost of repositioning the containers due to unbalanced trade, and the distribution of the cargo that is in the container to the consignees. The cost of using the container as the cargo carrier can represent a significant part of the total cost.

The fact that the container vessels with exception of feeder vessels equipped with cranes, require shore based cranes for unloading, limiting the ports that they can use to dedicated ports and are unable to serve less populated areas and, in particular, the developing world which lacks container ports.

When looking at the total logistic line from shipper to consignee, using available modes of transportation, there are significant time and cost elements caused by the use of containers which are not in harmony with JIT (Just In Time) modem logistic and industrial development.

The other type of vessel that carries non bulk ocean cargo is Ro-Ro vessels where the cargo is on wheels, such as cars, trucks or buses, and can be driven to the respective decks or is placed on trailers moved by a tractor to the designated deck position. The Ro-Ro vessels require a dedicated ramp in port which connects to the stem of the vessel to provide access for the Ro-Ro cargo. Alternatively the vessel can carry its own ramp, typical for car carriers. This type of vessel serves a market niche for cargo on wheels and special project cargo of outsize dimensions and weight.

### SUMMARY OF THE INVENTION

The object of the invention is to create a means of shipping cargo without necessitating the use of containers, to remove the bottleneck between vessel and pier and to eliminate the need for shore side cranes for loading and unloading the vessel and to expand the capabilities to carry, load and unload efficiently a great variety of different cargos.

This is achieved in a system for handling of a great variety of cargo as defined in the appended claim 1.

The system includes a vessel according to claim 2 with multiple decks to accommodate a handling technology where the cargo is stored on special load platforms (also called skids), as defined in claim 10, and is handled with a trolley defined in claim 7.

One of benefits of the invention is that the load platform, which has the footprint of a 40 ft ISO container, can carry any type of cargo that can be fitted within the footprint of the load platform including the ISO containers, greatly expanding the market potential of the vessel.

A vessel having three high speed elevators can unload/load 180 load platforms per hour, dramatically reducing in port time and, since the design of the onboard handling system provides flexible access to all cargo, making the vessel and its technology exceptionally well-suited to multiport liner service.

Since no shore equipment is required for the loading/unloading of the vessel, it can serve any port that can accommodate the length and draft of the vessel and is therefore also suitable for ports in the developing world.

### BRIEF DESCRIPTION OF THE DRAWINGS

The invention will now be described in detail with reference to the appended drawings, in which:

FIG. 1 is a perspective view of a vessel according to the present invention,

FIG. 2 is a plane view of one of the decks in the vessel,

FIG. 3A-E shows the handling of cargo on the deck shown in FIG. 2,

FIG. 4A, B shows the opening of the side doors,

FIG. 5 shows the mechanism behind a side door,

FIG. 6A-F is a sequence showing the unloading of a load platform with cargo through one of the side doors,

FIG. 7A-C is a perspective view of a load platform,

FIG. 8A-F is a perspective view of a load platform and a trolley adapted to handle said load platform

FIG. 9A-B shows the trolley in side view,

FIG. 10A-C shows details of the trolley,

FIG. 11A is a perspective view of a magazine for storing load platforms, and

FIG. 11B shows a detail of the magazine.

### DETAILED DESCRIPTION

The invention relates to a system for handling cargo on a cargo vessel and between vessel and quay. The system includes three elements: the cargo vessel, a load platform for storing goods, and a special trolley for transporting the load platforms.

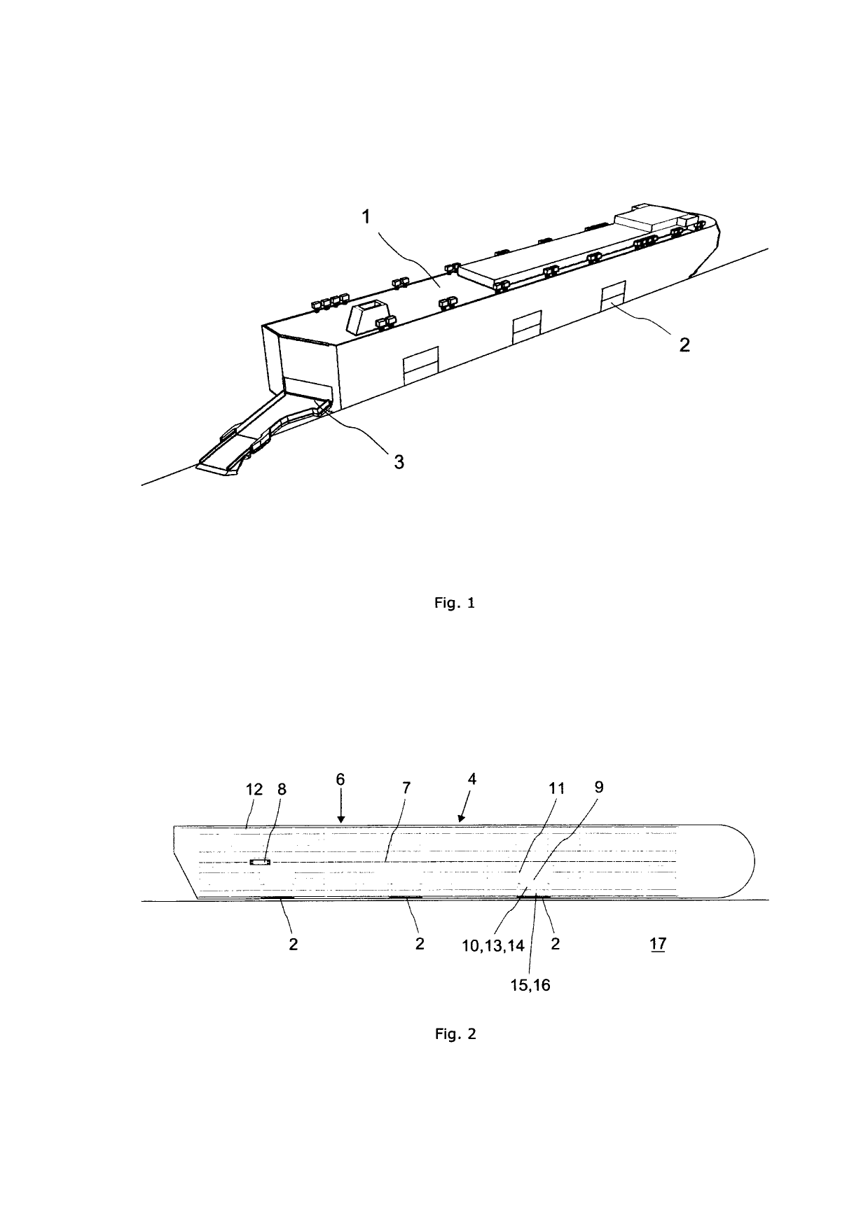

FIG. 1 shows a cargo vessel 1 according to the present invention. The vessel includes a number of decks, of which one, the main deck, is accessible through a number of side doors 2. All decks communicate by means of cargo elevators. In addition, there is an aft ramp 3 that folds down onto the pier giving access for cargo that cannot be mounted on standard size load platforms and for Ro Ro cargo. The aft ramp gives access to a particular reinforced deck that can support heavy goods.

FIG. 2 shows the main deck 4 in plane view. Cargo is located on load platforms 12 (to be described later) that are placed in short slots 6 transverse to the longitudinal axis of the ship, and with a central passageway 7. The load platforms are handled with a cargo transfer trolley 8 (also to be described later).

On the side of the vessel there are three side doors 2. At each side door there is a buffer station 9 preceding the cargo elevator 10. The buffer station includes a first conveyor means, such as a roller track 11. The trolley 8 can place a load platform 12 on said first conveyor means 11 in the buffer station 9 for transfer to the elevator 10. The cargo elevator 10 includes an elevator platform 13 with a second conveyor means 14 for receiving the load platforms. Next to the elevator, just inside the door, is located a third conveyor means 15 and a crane device 16.

When unloading the vessel, the trolley 8 is adapted to deliver load platforms 12 to the first conveyor means 11 and unload the load platform. The load platform may then pass the buffer station 9 and proceed onto the elevator platform 13. The elevator 10 will adjust its height until the second conveyor means 14 are level with the third conveyor means 15, and the load platform may then roll further onto the third conveyor means 15. At this point, the load platform is lifted by the crane device 16 and delivered onto the quay 17. From there, the load platform may be collected by any suitable portside truck/trolley/translifter and transported onward. Cargo may also be transported the other way around, i.e. collected from the quay and taken into the ship.

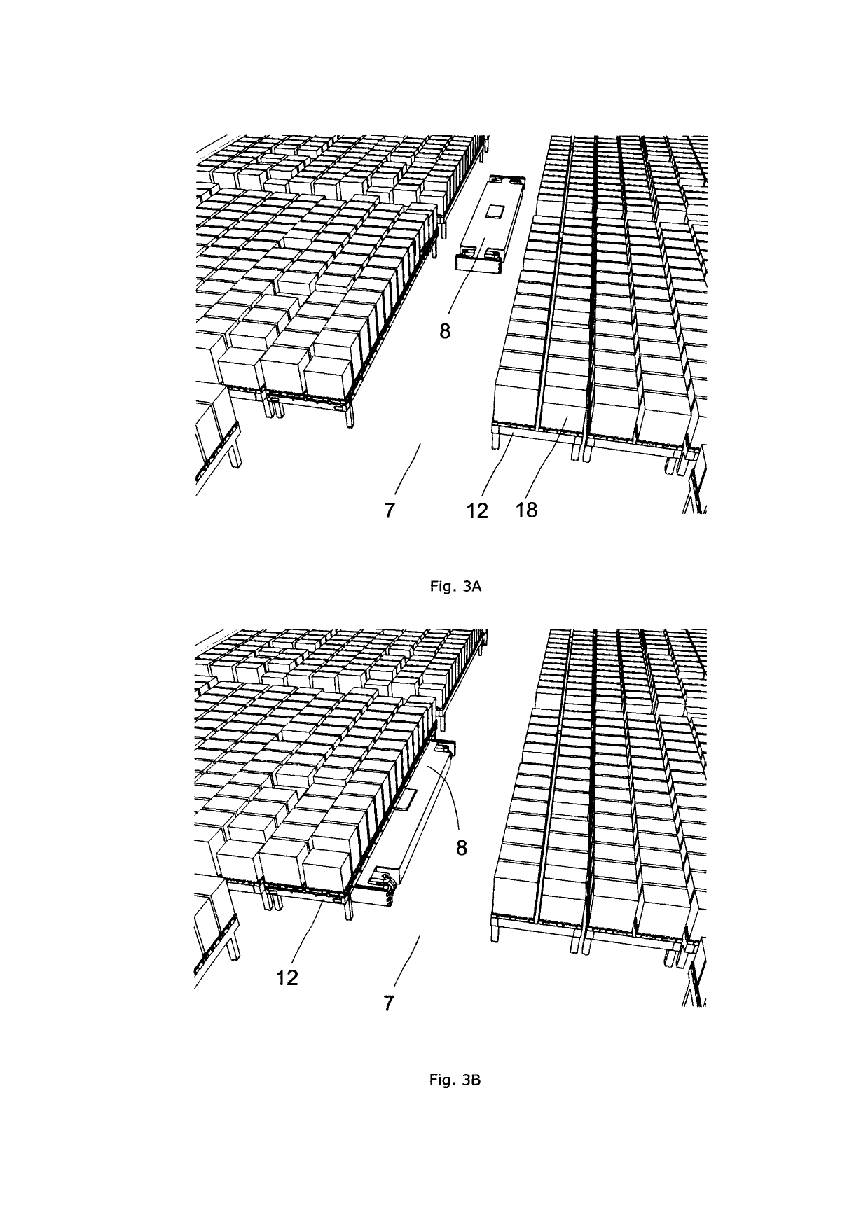

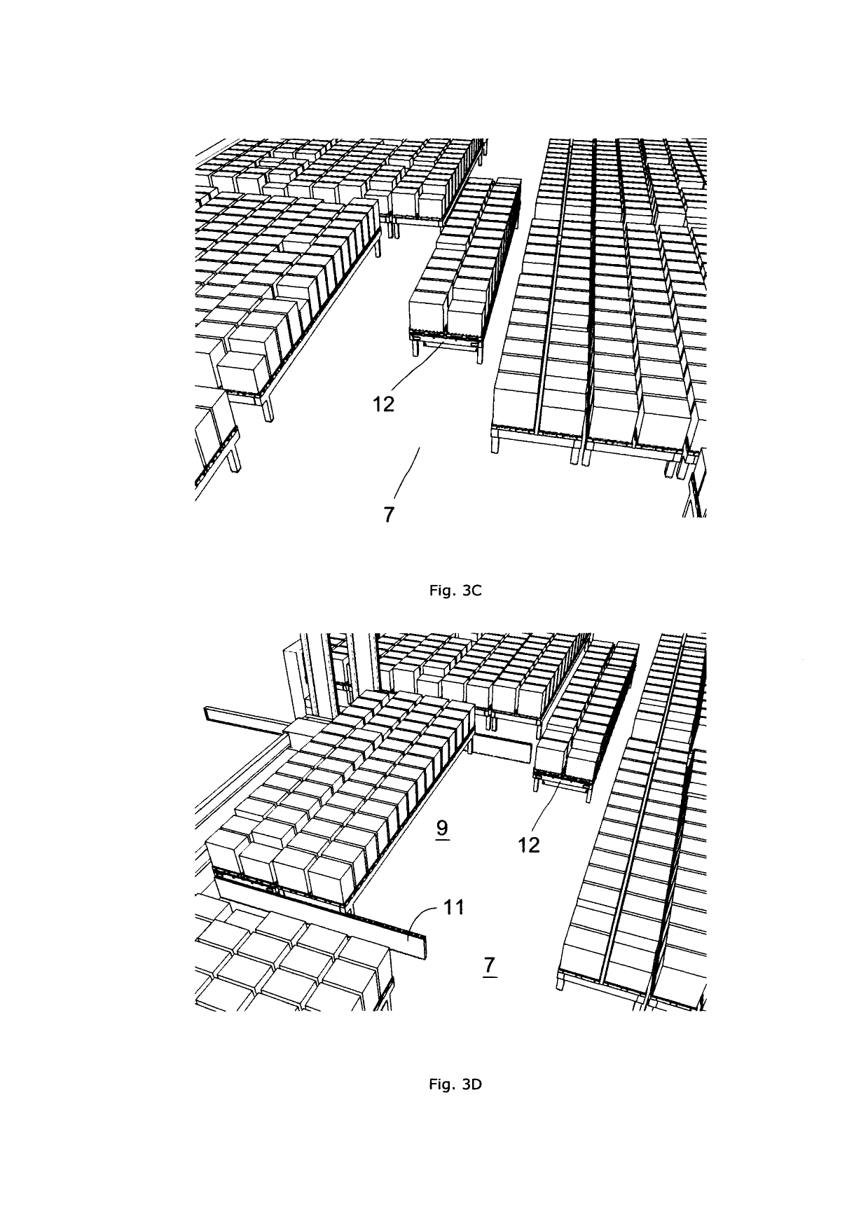

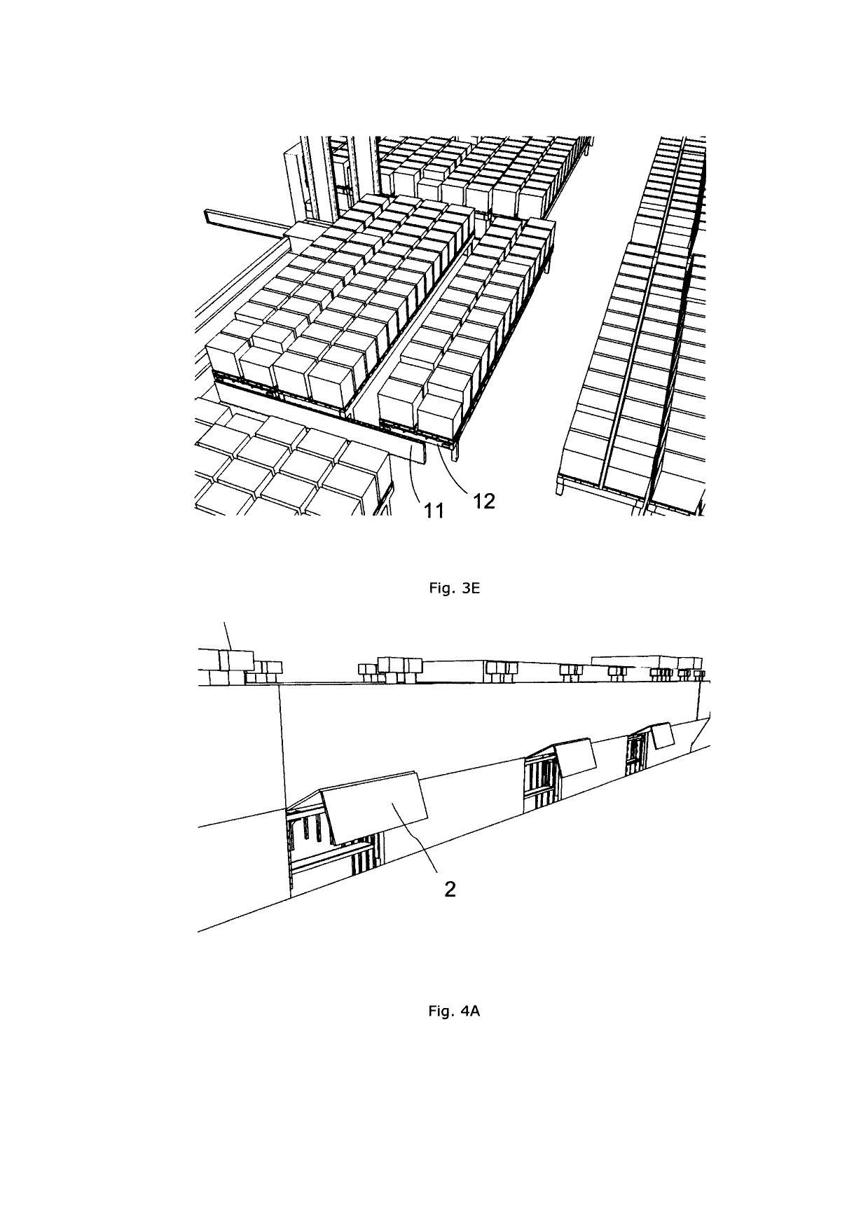

FIG. 3A shows a trolley 8 coming along the passageway 7 in order to collect a load platform 12 with goods 18.

In FIG. 3B the trolley is moving in the transverse direction passing below the load platform 12. The trolley will then lift the load platform off the deck and start moving the load platform down the passageway towards side door, FIG. 3C.

In FIG. 3D the trolley is approaching a side door, and in FIG. 3E it has started unloading the load platform on the first conveyor means 11.

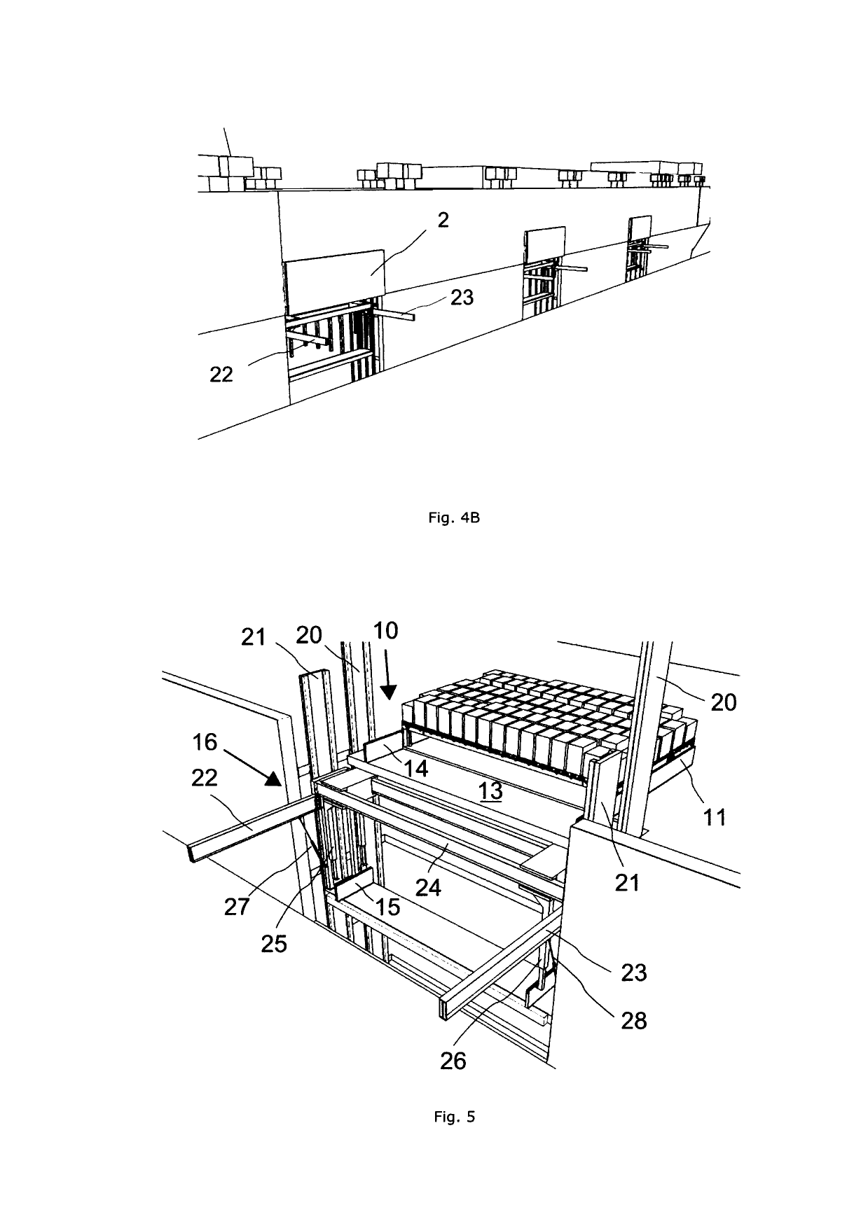

FIG. 4A shows the opening of the side doors 2. Thereafter a number of crane beams 19, two in each door opening 2, are folded out.

FIG. 5 is a detailed sketch of the arrangement behind each side door. On the deck there is a first conveyor means 11 on which the trolley is storing load platforms. In front of the first conveyor means 11 there is an elevator shaft with vertical elevator guide rails 20 along the sides. The elevator shaft runs through all decks. In the elevator shaft there is suspended an elevator platform 13 running along the elevator guide rails. The elevator platform 13 is equipped with a second conveyor means 14 which can communicate with the aforementioned first conveyor means 11 for transferring load platforms. At the level of the side door opening there is a crane arrangement 16 adapted to transfer the load platforms between the elevator platform and the quay. The crane arrangement includes a third conveyor means 15 for receiving load platforms, crane guide rails 21, hinged side beams 22, 23, a portal crane 24 spanning the side beams 22, 23 and telescopic arms with lifting hooks 25, 26. The side beams 22, 23 are folded up and down by means of hydraulic cylinders 27, 28.

The crane arrangement and the third conveyor include means for compensating for movements between the vessel and the quay. Such movements may be due to tidal variations, re-ballasting of the vessel, currents in the harbour, etc. To compensate for such changes, in both the vertical and the longitudinal planes, an optical target may be located on the quay. Sensors on board the vessel, such as cameras can then observe the position of the target and compensate for any movements of the vessel with the telescopic arms and the portal crane.

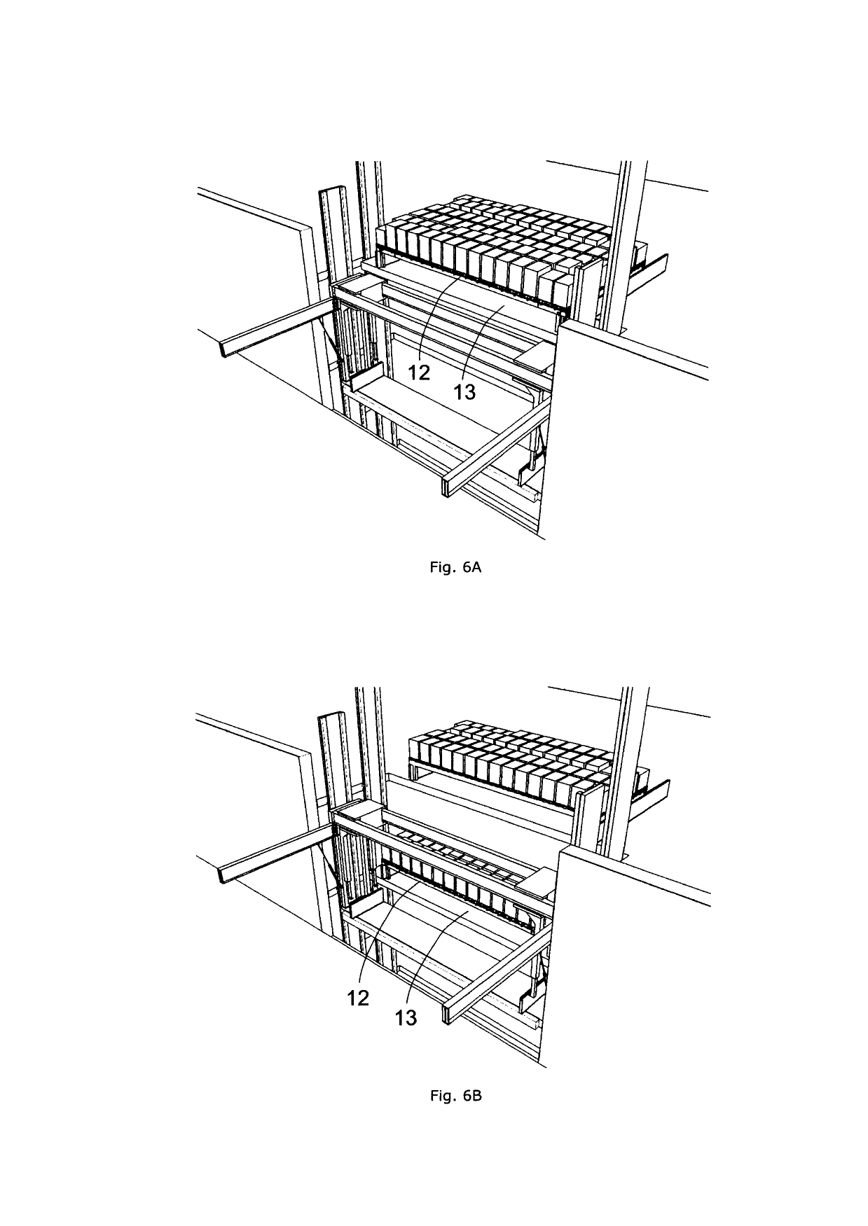

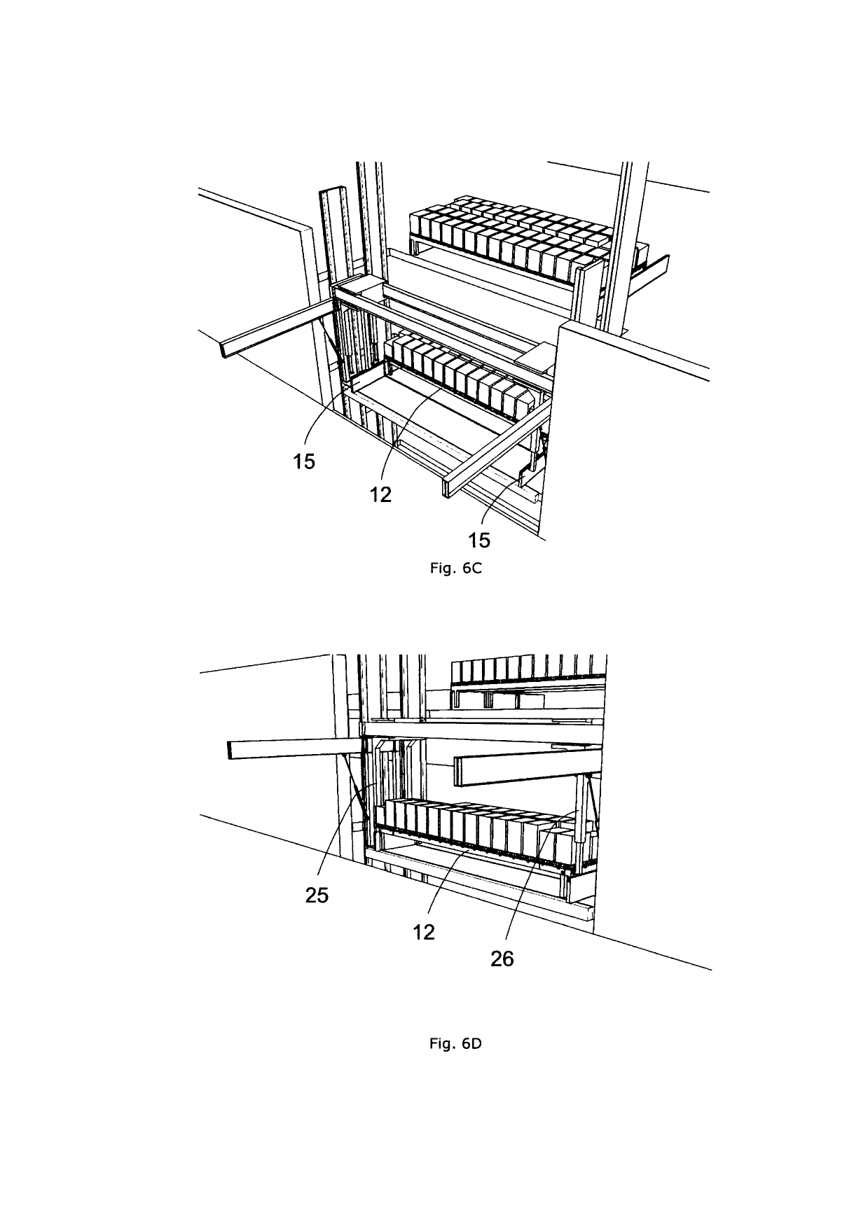

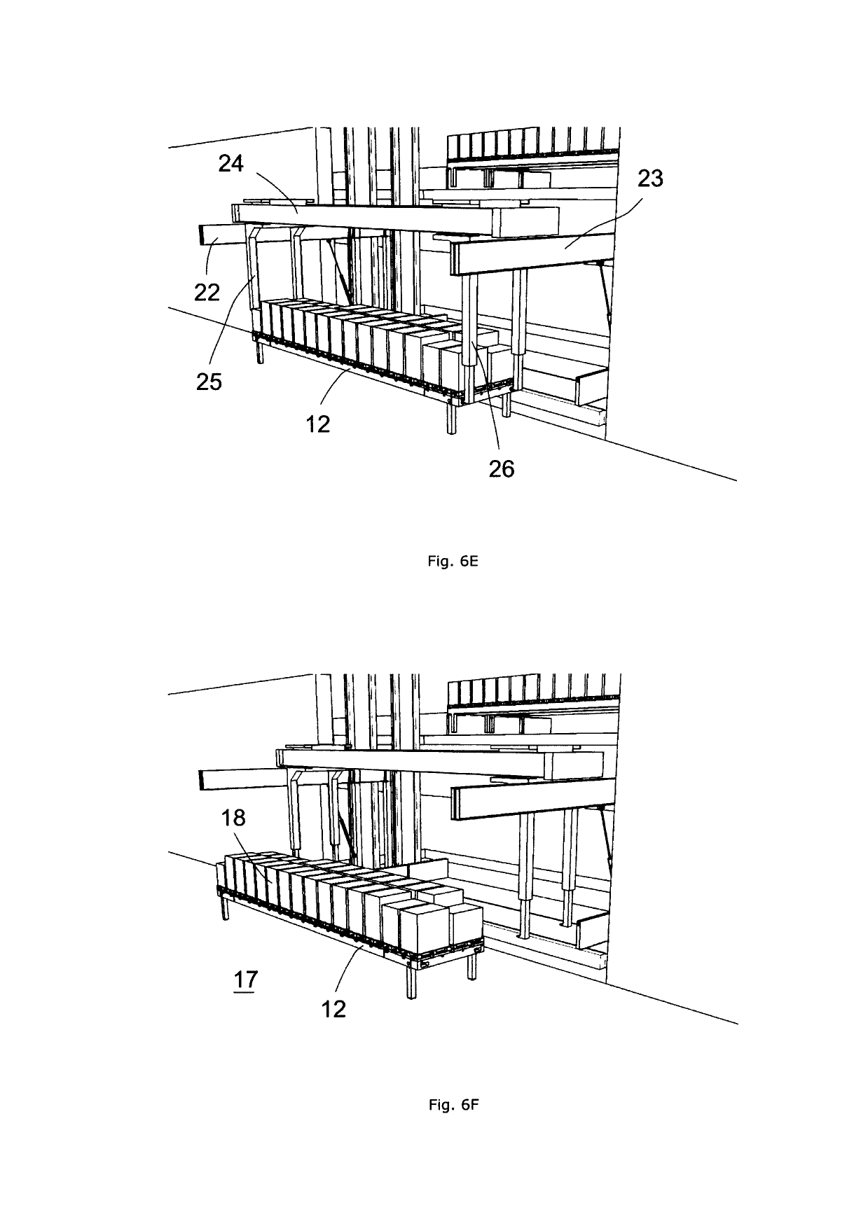

FIG. 6 shows in sequence how a load platform 12 is rolled onto the elevator platform 13, FIG. 6A. In FIG. 6B the load platform is lifted down to the level of the side door. In FIG. 6C it is rolled onto the third conveyor means 15. In FIG. 6D the lifting hooks 25, 26 have engaged the load platform 12, and in FIG. 6E it is being transferred along the side beams out of the side door. Lastly, in FIG. 6F the load platform is lowered onto the quay.

To allow the vessel to sail in high seas, the load platform will be locked to the deck with sea fastenings. The sea fastenings could be of any type suited for the purpose, but will normally be activated automatically or remotely, i.e. without human personnel present on the deck. The fastenings will not involve a major structural change to the vessel, i.e. they can be removed easily if the vessel is to be converted for another use. There are known several prior art fastening systems that may be modified for use in cargo vessels according to the present invention. Examples of such systems may be found in U.S. Pat. Nos. 6,435,796 and 6,709,208.

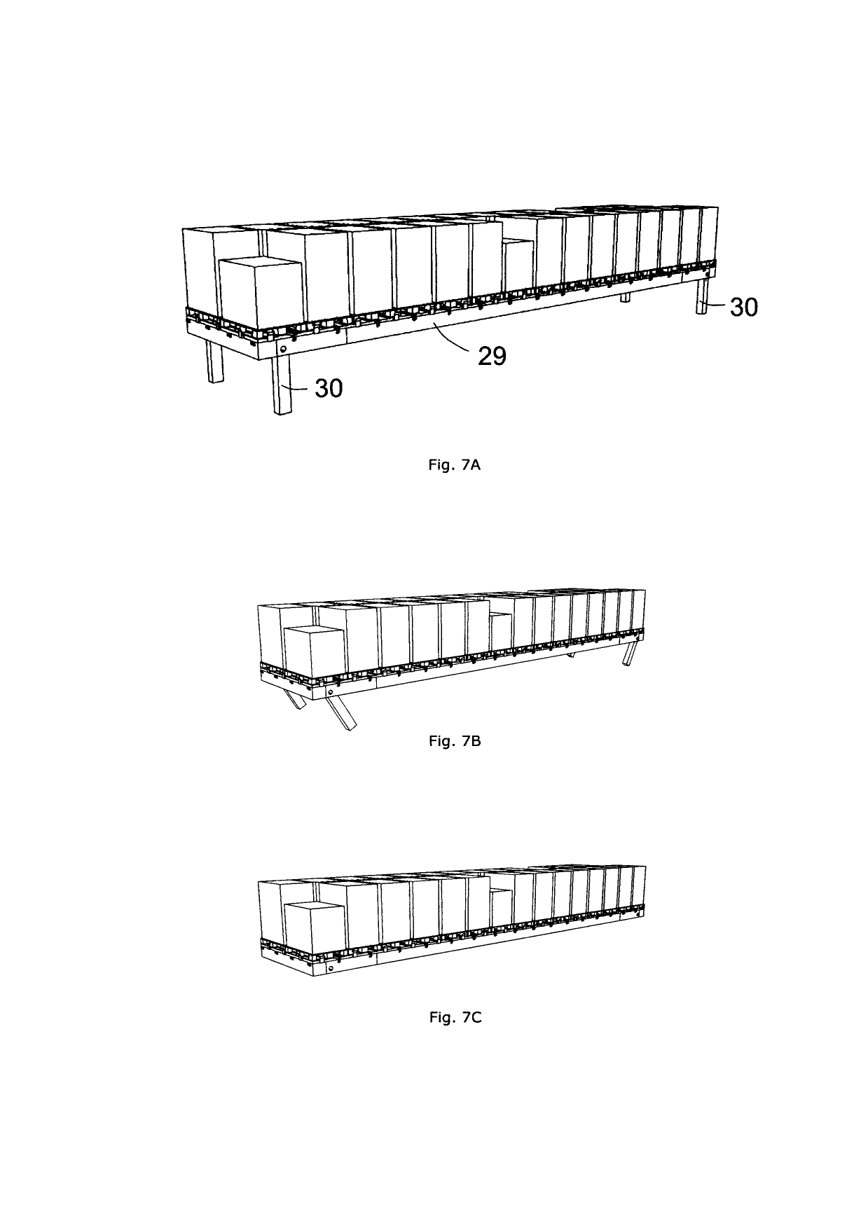

FIG. 7 shows a load platform 12 according to the invention. The load platform includes a structure or platform 29 with a foldable leg 30 in each corner. The legs are operated by a mechanical arrangement inside the structure (not shown). The load platform is fully passive, i.e. does not contain any drive mechanism, but is dependent on being connected to an external drive through a connector on the underside of the platform for folding/unfolding the legs. The folding of the legs makes the load platform conveyable on mechanized conveyors.

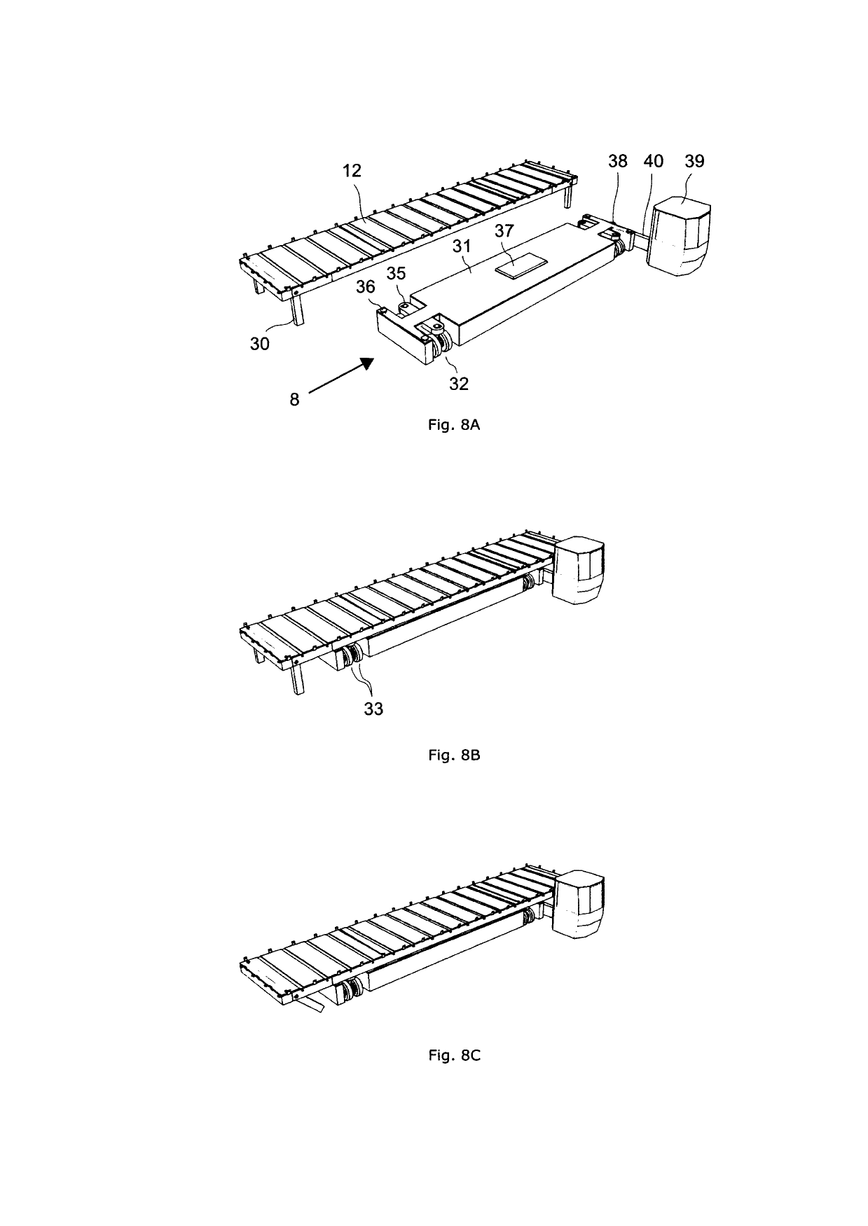

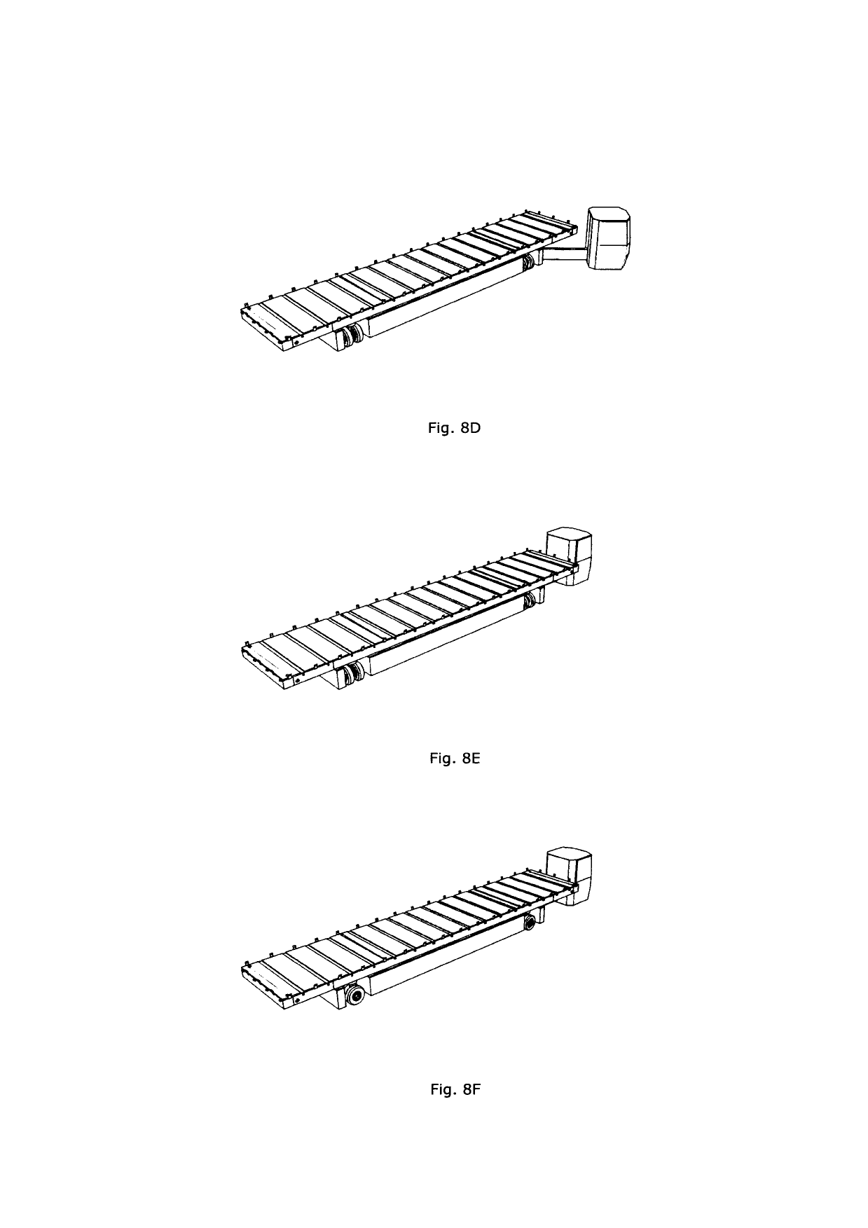

FIG. 8 shows the design of the trolley 8. The trolley includes a chassis 31 with a wheel arrangement 32 in each corner. Each wheel arrangement consists of two wheels 33 with a motor 34 inside each wheel rim. The wheel pair is mounted on a vertical shaft 35. In the upper end of the vertical shaft there is a drive mechanism inside the chassis allowing the wheel arrangement to be turned 360° around. This particular wheel arrangement allows the trolley to go in any desired direction. The use of a wheel pair arranged centrally about the vertical turning shaft means that the wheels may be turned without moving the trolley. In this embodiment of the trolley there is a jacking mechanism 36 in each corner for lifting the load platform.

Further, the trolley includes a drive mechanism with a connector 37 on the upper side of the chassis for mating with a corresponding connector on the underside of the load platform, for folding or un-folding the legs. The connector is connected to a drive unit for providing a rotational force to the legs of the external load platform through the connector. The connectors s on the load platform and trolley may be realized in several ways, e.g. as a pinion on the trolley connecting with a rack on the load platform, which when activated provides a rotational force to turn the legs of the load platform into the up or down position via a gear driving through a common axle for each pair of legs.

The trolley may be powered by a conventional diesel-electric engine arrangement. However, as it may be used within a confined compartment, it is preferred to use a less pollutant drive solution. This may be a large battery inside the chassis, or a large bank of capacitors. Any drive solution known in the art may be used for the purpose.

The trolley is adapted for fully automatic, semi-automatic or manual control. For automatic control, the trolley includes a controller unit as well as a communication unit adapted to receive instructions from a remote control centre onboard the vessel through wireless means. That is, the controller in the trolley receives orders to perform specific tasks from the control centre, and performs the tasks on its own. To allow the control centre to determine the position of the trolley and/or the trolley to know its position, the trolley includes a number of sensors adapted to read markings on the deck. The markings may be mechanical, optical or magnetic, e.g. as labels put on the deck. The trolley may then navigate its way through the vessel using these markings. Such markings may also be active, e.g. light sources.

In another embodiment, the trolley may also be remote controlled from the control centre, by the control centre determining the position of the trolley in real time from sensors located on the deck (or by receiving position readings from the trolley). Sensors located on the deck may read markings put on the trolley. Thus, the control centre may issue wireless steering signals to the trolley. The trolley may also be remote controlled by an operator observing the trolley with a camera. A system with markings and sensors may then assist the operator for accurate navigation of the trolley.

Lastly, the trolley includes at least one connector 38 allowing a detachable cabin 39 to be connected to the trolley for fully manual control. The cabin is releasably connected to the chassis through a revolving and telescopic shaft or arm 40. This may be beneficial as a back-up solution in case there is a break-down in any part of the automated control systems. With a cabin, the trolley may also be used off the vessel, e.g. on a quay without any control system. Manual control may also be used on vessels that are not equipped with an elaborate control centre. This embodiment is illustrated as in FIG. 8 as a sequence of steps showing how the cabin 39 is connected to the trolley (A), the trolley then being moved below the load platform (B), the trolley lifting the load platform, connecting to the load platform and folding the legs on the load platform (C) to let the cabin be relocated (D), turning the wheels into the appropriate direction (E) and transporting the load platform away in the longitudinal direction (F).

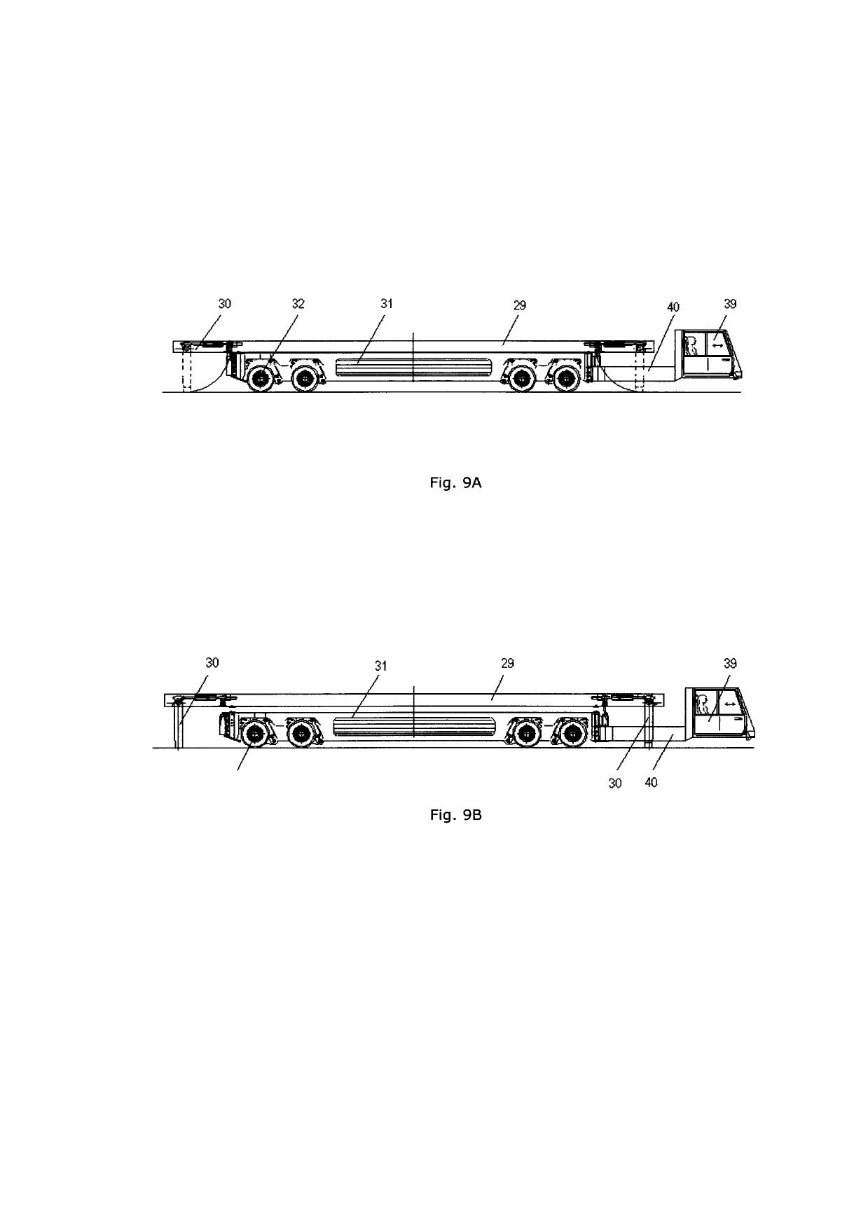

FIG. 9A-B shows a load platform and trolley in side view. The trolley is a heavy duty version, with a double set of wheel arrangements. FIG. 9A shows the load platform mounted on the trolley with the legs turned up. In FIG. 9B, the load platform has been lifted up, the legs turned down and the load platform subsequently lowered onto the ground. The trolley may then drive forward leaving the load platform behind.

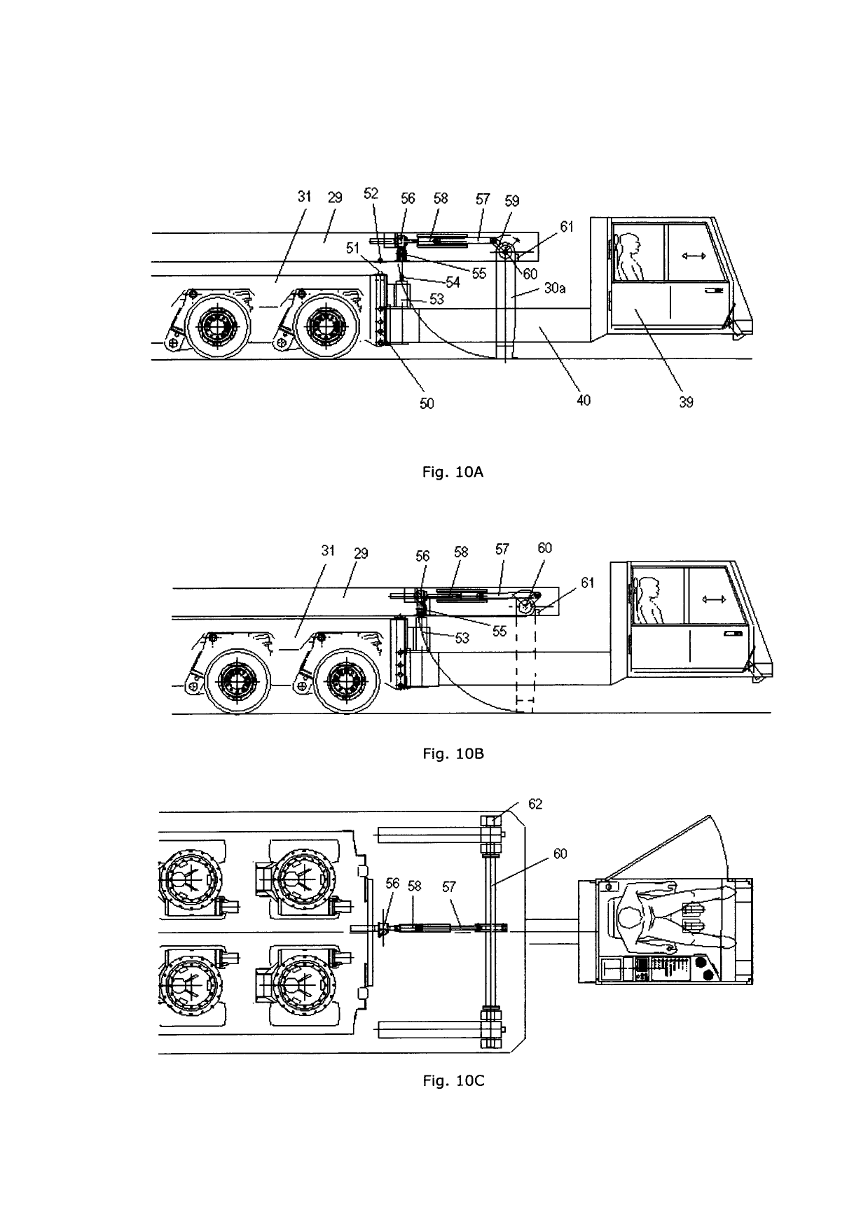

FIG. 10 shows the mechanism for raising and lowering the legs in detail. In FIG. 10A, the load platform is standing on the floor on its legs. The trolley is located below the load platform ready to collect it for transport to another location. The trolley is a heavy duty version with double sets of wheel arrangements 32.

In FIG. 10B the trolley has lifted the load platform from the floor and turned the legs up. A cabin 39 is mounted on the trolley chassis through an arm 40. The arm is connected to the chassis in a hinge 50 allowing the cabin to turn to the sides. The trolley may also include a mechanism allowing the hinge to be shifted towards the sides. This version of the trolley is adapted to lift the load platform by raising the wheel arrangements, e.g. by cylinders lifting the chassis from the wheel arrangements. A hemispherical bracket 51 on the trolley is adapted to engage a mating bracket 52 on the load platform, the brackets preventing any relative movement between the load platform and trolley.

The trolley also includes a drive unit 53 with a liftable spline shaft 54. The spline shaft is adapted to be lifted into and engage a corresponding friction coupling 55 on the load platform. The friction coupling 55 is connected to a worm gear screw jack 56 with self locking gear ratio, which on the other hand is connected to a push/pull link bar 57 suspended in a guided sliding bracket 58. The link bar 57 transfers linear movements from the screw jack to a pin 59 on a rotating shaft 60 connecting the legs 30a, b. The shaft 60 is suspended in the chassis in bearings 62 at each end thereof. A tilt stop bracket 61 is included to prevent the legs from spreading too far. Corresponding mechanisms are located at the aft ends of the trolley and load platform, as illustrated in FIG. 10.

When operating the trolley to raise or lower the legs 30a, b, the spline shaft 54 is lifted to engage the friction coupling 55 on the load platform. The drive unit 54 is operated to rotate the shaft. This rotating movement is translated into a linear movement in the screw jack 56, and further transferred to the pin 59 via the link bar 57. The pin 59 will then rotate the shaft 60 causing the legs to be raised from or lowered to the ground, respectively.

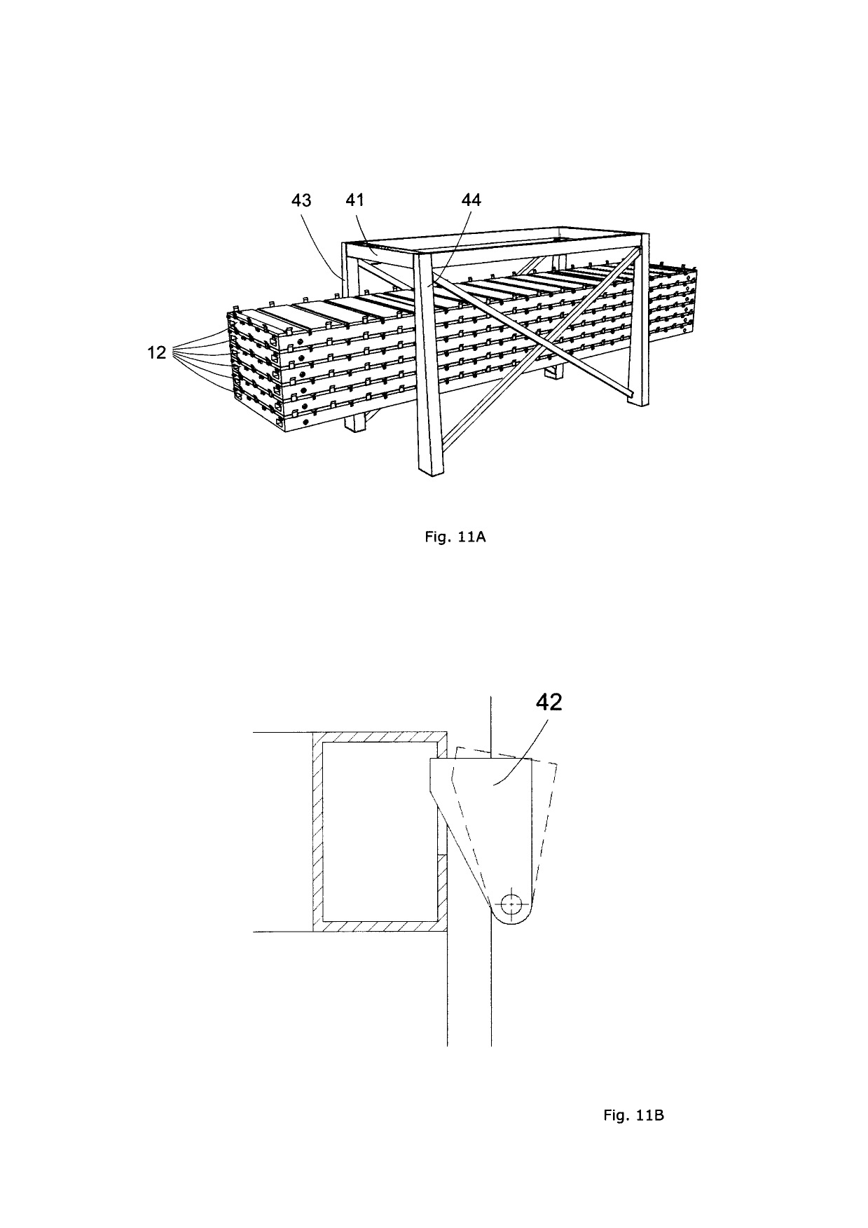

In FIG. 11A a magazine for storing load platforms is shown. Such magazines could be located on board the ship and in ports. The magazine includes a rectangular frame structure 41 with four legs forming a first 43 and second 44 pair of legs. Load platforms may be stored in the magazine (with the legs folded) forming a stack arrested by a number of spring loaded keys 42 (FIG. 11B). A trolley transporting a load platform may enter the magazine and raise its jacks. The load platform will lift the stack until it engages the keys 42 and is locked. Then, the trolley will lower the jacks and go to fetch another load platform. Instead of pairs with legs, elongate pillars may be used, each with two keys for holding the stack of load platforms.

A stack of load platforms may be removed by a trolley by lifting another load platform from below until it engages and lifts the stack. The keys are forced outward and the upward movement must be terminated before the keys enter below the lowermost load platform. In this position the trolley may go forward and remove the stack.

The invention is illustrated using roller tracks as conveyors for storing and transporting load platforms over small distances. However, any other conveyor suited for the purpose may be used, such as band conveyors.

1-15. (canceled)

16. A system for handling cargo on board and to/from a vessel,
said system including a cargo vessel with a plurality of cargo decks, a number of side doors, a cargo elevator located inside each side door communicating with said cargo decks, and a crane located inside each side door,
wherein the system further includes a number of standardized cargo load platforms with foldable legs, the cargo load platforms being adapted to store cargo, the cargo load platforms being stored on the cargo decks in slots along the sides of the vessel and transverse to the longitudinal axis of the vessel and with a passageway between the slots along the longitudinal axis of the vessel, and
the system further includes a number of trolleys adapted to transport the load platforms between the slots and the cargo elevators, the trolleys being adapted to fold or unfold the legs on the load platforms.

17. A cargo vessel with a plurality of cargo decks and a number of side doors, a cargo elevator located inside each side door communicating with said cargo decks, and a crane located inside each side door, said crane being adapted to move cargo between the vessel and a quay,
wherein the cargo is stored on standardized cargo load platforms with foldable legs, each cargo load platform is adapted to be transported with a trolley, where the trolley is adapted to fold or unfold the legs on the cargo load platform, each cargo deck being adapted to store the cargo load platforms in slots along the sides of the vessel and transverse to the longitudinal axis of the vessel and with a passageway between the slots along the longitudinal axis of the vessel.

18. The cargo vessel in claim 17, further including mechanical, optical or magnetic markings on each deck for the navigation and positioning of the trolley, and/or on the trolley itself, and sensors for reading said markings

19. The cargo vessel in claim 17, further including a controller controlling the position of the trolley, said controller communicating with the trolley through wireless means.

20. The cargo vessel in claim 17, further including a buffer station at each side door for storing load platforms, said buffer station including first conveyor means.

21. The cargo vessel in claim 17, wherein the cargo elevator includes an elevator platform with a second conveyor means.

22. The cargo vessel in claim 17, wherein the crane includes a third conveyor means for receiving load platforms, crane guide rails, side beams hinged to the crane guide rails, hydraulic cylinders for folding and unfolding the side beams, a portal crane spanning the side beams and telescopic lifting hooks.

23. The cargo vessel in claim 20, wherein said first, second and third conveyor means are roller tracks.

24. The cargo vessel in claim 22, wherein the crane includes means for compensating for movements of the vessel with the telescopic arms and the portal crane.

25. A cargo trolley adapted for use with a cargo load platform with foldable legs, the cargo trolley including a chassis with a number of turnable wheel arrangements, at least some of the wheel arrangements being driven by electric motors, said trolley further including lifting means,
wherein the trolley includes a mechanical connector with drive means adapted to fold or unfold the legs on the cargo load platforms, and a detachable operator cabin that may be connected to the trolley for manual control of the trolley, the cabin being connected to the trolley with a telescopic and turnable arm, whereby the trolley may be controlled manually, semi-automatically or fully automatically.

26. The cargo trolley of claim 25, wherein the trolley is adapted to be positioned below a cargo load platform with foldable legs, lift the cargo load platform from the support into a transport position with the lifting means, connect the drive means to a mating connector in the cargo load platform and fold or unfold the legs using the drive means.

27. The cargo trolley of claim 25, wherein the trolley includes means for remote control.

28. A cargo load platform with a platform structure and a number of legs, the cargo load platform being adapted to be transported with a cargo trolley,
wherein a mechanism is provided for folding the legs into and out of the structure, said mechanism being activated through a mechanical connector on the underside of the cargo load platform for connecting to an external drive means, where the external drive means is activated by the cargo trolley.

29. A magazine for storing a number of cargo load platforms with a platform structure and a number of legs, wherein a cargo load platform is adapted to be transported with a cargo trolley, and where the cargo load platform is provided with a mechanism for folding the legs into and out of the structure, said mechanism being activated through a mechanical connector for connecting to an external drive means, where the external drive means is activated by the cargo trolley,
wherein said magazine includes a rectangular frame structure with a first and second pair of legs or two pillars, the distance between the two pairs or pillars being wide enough to accommodate a load platform in the longitudinal direction, each leg or pillar including at least one spring loaded key for engaging and holding a load platform, the magazine is adapted for use with a cargo trolley, where the cargo trolley may enter the magazine and effecting lifting of the number of cargo platforms in the magazine for locking or removing at least a cargo load platform from the number of cargo load platforms in the magazine.

30. A method for transporting palletized cargo stored on a load platform with foldable legs, including the steps of
positioning a trolley below the load platform
lifting the load platform with the trolley,
connecting a drive unit in the trolley to the load platform,
folding in the legs of the load platform using said drive unit,
transporting the load platform with the trolley to another location, and either
lowering the load platform onto a conveyor, or
folding out the legs using the drive unit in the trolley, and then lowering the load platform to the ground standing on the legs.

31. The cargo vessel in claim 21, wherein said first, second and third conveyor means are roller tracks.

32. The cargo vessel in claim 22, wherein said first, second and third conveyor means are roller tracks.
